(19) United States
(12) Patent Application Publication
(10) Pub. No.: US 2025/0236494 A1
(43) Pub. Date: Jul. 24, 2025

(54) RING GEAR CABLE WINCH

(71) Applicants: Steven KREYSSIG, Hochdorf (DE); Hubertus RÜTTEN, Riedlingen (DE)

(72) Inventors: Steven KREYSSIG, Hochdorf (DE); Hubertus RÜTTEN, Riedlingen (DE)

(21) Appl. No.: 19/178,691

(22) Filed: Apr. 14, 2025

Related U.S. Application Data
(63) Continuation of application No. PCT/EP2023/076724, filed on Sep. 27, 2023.

(30) Foreign Application Priority Data
Oct. 13, 2022 (DE) 10 2022 126 670.2

(51) Int. Cl. B66D 1/22; B66C 19/00; F16D 9/06; F16H 57/04

(52) U.S. Cl. CPC B66D 1/22; F16D 9/06; F16H 57/0452; F16H 57/0457; F16H 57/046; F16H 57/0476; B66C 19/002

(57) ABSTRACT

The invention relates to a ring gear cable winch having a cable drum and a drive device for driving the cable drum, wherein the drive device comprises a ring gear connected to the cable drum in a rotationally fixed manner and a plurality of drive motors arranged distributed over the circumference of the ring gear, and each drive a drive pinion meshing with the ring gear, wherein the drive pinions are connected directly to the drive motors without gearing and rotate at the motor shaft speeds of the drive motors.

### CROSS-REFERENCE TO RELATED APPLICATIONS

This application is a continuation of International Patent Application Number PCT/EP2023/076724 filed Sep. 27, 2023, which claims priority to German Patent Application Number DE 10 2022 126 670.2 filed Oct. 13, 2022, which are incorporated herein by reference in their entireties.

### BACKGROUND

The present invention relates to ring gear cable winches having a cable drum and a drive device for driving the cable drum, wherein the drive device comprises a ring gear connected to the cable drum in a rotationally fixed manner and a plurality of drive motors arranged distributed over the circumference of the ring gear, and each drive a drive pinion meshing with the ring gear.

Cable winches for container cranes or other lifting gear that lift heavy loads and are used intensively in this case, i.e. not only have to perform individual lifts with longer downtimes in between, but also run more or less continuously, are often generously dimensioned in terms of the drive train and configured in such a way that they can withstand continuous operation with high loads in order to avoid the risk of downtimes. However, such a jib winch design impairs energy efficiency and is also detrimental to lifting dynamics, as the correspondingly dimensioned drive motors and transmissions have to be accelerated and decelerated and accelerated again with each lift. In this case, the inertia of the drive systems not only worsens the dynamics of the lifting process as such, but also results in increased energy consumption.

Up to now, container winches have usually been driven via a spur gear, which not only helps to drive the drive motors in a favorable speed range by means of a corresponding transmission/reduction ratio, but also allows several drive motors to be connected and synchronized with each other, for example by means of a common spur gear, which is driven jointly by the several motors and then transmits the drive movement to the cable winch via further spur gears. In this case, it is not only said inertia of the drive train that is a problem, but also the several times pinion engagement, which causes drive losses and also reduces the rigidity of the drive train, which can be felt when positioning a high load precisely or setting it down gently.

Cable winches that are not driven via a spur gear but via a ring gear are known, for example, from the patent document WO 2014/114440 A1. In this case, ring gears are mounted on the flanged pulleys of the cable winch, which mesh with drive pinions, each of which is driven by an electric motor. In this case, the respective pinion is coupled to the motor shaft of the drive motor via a planetary gear in order to be able to realize a sufficiently high transmission or reduction ratio in a small installation space, which allows cable winch operation at the usual motor speeds. A similar ring gear drive is also shown in the patent document EP 22 80 191 A2.

It is the underlying object of the present invention to provide an improved ring gear cable winch of the type said above, which avoids the disadvantages of the prior art and further develops the latter in an advantageous manner. In particular, a highly efficient and dynamic hoisting operation is to be made possible and, in this case, a very high level of reliability and ease of maintenance are to be achieved simultaneously, without the need for special motors or gear elements made of expensive high-tech materials that are difficult to procure. Preferably, the ring gear cable winch should be able to withstand continuous container handling operation at high capacities.

### SUMMARY

According to the invention, said object is achieved by a ring gear cable winch according to claim 1 and a lifting gear according to claim 20. Preferred embodiments of the invention are the subject-matter of the dependent claims.

It is therefore proposed to distribute the drive power required to drive the cable drum to several relatively small-sized drive motors and to operate these at relatively high speeds in order to enable higher final speeds for empty runs thanks to a larger speed band. According to the invention, it is provided that the drive pinions meshing with the ring gear are connected directly to the drive motors without gearing and rotate at the motor shaft speeds of the drive motors. The drive pinions are therefore driven by “their” motor shafts without over/under reduction, so that the lack of gear stages between the motor shafts of the drive motors and the drive pinions meshing with the ring gear not only reduces the inertia of the drive train and increases its rigidity, which enables a more dynamic drive behavior overall, but also allows smaller or less inertia drive motors to be used, which are more marketable and therefore more readily available.

Simultaneously, the distribution of power to several drive motors and several independent gear meshes on the ring gear can ensure an overall system design with several times redundancy, as the drive power of the several drive motors is transmitted to the ring gear via independent paths, so that in the event of a drive motor and/or drive train failure, the drive power of the remaining drive motors is still effective and can be transmitted to the ring gear. Nevertheless, losses can be reduced or kept to a minimum despite the multiple independent tooth meshes on the ring gear, as the number of tooth meshes is still comparatively small when compared to drive solutions with multiple drive motors and multi-stage spur gears or planetary gears.

The drive motors used in this case can be, in particular, gearless electric motors whose motor shaft directly drives the assigned drive pinion, which meshes with the ring gear, without gearing or reduction ratios. This makes it possible to combine high efficiency with simultaneous simple, precise controllability.

In an advantageous further development of the invention, more than three or more than four drive motors can be provided and connected to the same ring gear, wherein more than five or more than six drive motors can also be arranged distributed over the circumference of the ring gear and can each drive the ring gear via a drive pinion.

Advantageously, the drive pinions and the ring gear are configured in terms of their number of teeth or the transmission/reduction ratio in such a way that the drive motors can run at motor speeds in the range of 3,500 to 7,000 rpm or 3,500 to 6,000 rpm or, advantageously, 4,000 to 5,000 rpm when driving the cable drum as intended. While container winches are conventionally driven by drive motors with speeds of 2,000 to 3,000 or a maximum of 3,500 rpm, significantly faster drive motors can be used to achieve higher empty travel speeds in particular. The drive motors can, of course, also be operated at speeds of less than said 3,500 rpm, for example to gently lower a container onto the ground or to perform other fine positioning tasks. However, the high-speed ranges as said are advantageous for intended travel movements such as empty runs. As every second journey in container handling, namely the journey from the drop-off point back to the pick-up point, is usually an empty journey, the handling capacity can be increased considerably if the empty journeys are accelerated. Despite lower power, the empty run speed can be significantly increased by higher speeds, as a wider speed range is available overall and no high power is required for the empty run due to the lack of a high load.

Advantageously, the drive motors can be configured to each have a moment of inertia of less than 2 kgm² or less than 1 kgm². For example, if six drive motors with a maximum moment of inertia of 1 kgm² each are used, the total inertia of all the drive motors driving a ring gear together is only 6 kgm², which enables very dynamic drive behavior. Simultaneously, in the event of a so-called snag load, when a container or load gets caught, the lifting gear is subjected to less stress due to the rapid deceleration of the rotating masses.

In order to be able to continue operating the cable winch without major consequences if a drive motor or a drive train between one of the drive motors and the ring gear fails, a control device for controlling the drive motors can be provided, which has a failure operation mode in which, if the drive power of one or more drive motors fails, for example due to a break in the shaft connection between the drive pinion and motor, the drive powers of the remaining drive motors are increased to such an extent that the missing drive power is at least partially compensated. In particular, the drive power of the remaining, operational drive motors is increased uniformly or to the same extent, so that each of the remaining drive motors only contributes a small part to compensating for the missing drive power. As a result, all remaining drive motors are uniformly more heavily loaded, but as little as possible.

Advantageously, said failure operation mode can comprise at least two compensation stages. For example, a power mode can be provided in which the missing drive power is substantially fully compensated for by increasing the drive power of the remaining drive motors, so that a largely loss-free handling operation can continue to be ensured. Advantageously, the failure mode can also have an economy mode or efficiency mode in which the missing drive power is only partially compensated for by increasing the drive power of the remaining drive motors. Such an economy mode avoids increased wear of the drive motors and drive trains operated at higher power and can be particularly useful if the cable winch does not have to lift maximum loads, but instead handles comparatively light containers, for example, or if losses in handling capacity are negligible because the time available for unloading a load is sufficiently long.

Advantageously, the control device can be configured to automatically switch to failure operation mode as required, in which the missing drive power of a failed drive is at least partially compensated for by increasing the power of the remaining drives. This makes it possible to achieve a substantially seamless transition to failure mode without suffering major drops in speed and the associated rocking movements. Advantageously, a detection device can detect the drive power failure of each drive motor, wherein the detection device can, for example, detect the power consumption of the individual drive motors and determine a failure based on the power consumption detected in each case. If the power consumption of a drive motor decreases for a short time, for example because the shaft connection to the drive pinion is broken, the detection device can identify such a decrease in power consumption as a failure, whereupon the control device can control the remaining drive motors in such a way that they compensate or partially compensate for the power that has decreased.

In order to achieve efficient operation with as little loss as possible, oil lubrication or wet lubrication with a suitable lubricant can be provided for the drive pinions in an advantageous further development of the invention.

In a further embodiment of the invention, such oil or wet lubrication can comprise an oil or lubricant bath in which at least a lower part of the ring gear is immersed and/or at least one drive pinion arranged at the lower region of the ring gear is immersed.

In order to be able to lubricate as many drive pinions as possible in the oil or lubricant bath, but still not require an oil or lubricant bath level, the drive pinions can, in an advantageous further development of the invention, be arranged concentratedly towards a lower part of the ring gear, so that all drive pinions run in the oil bath or pass through the oil bath. For example, the drive pinions can all be arranged concentratedly in the lower half of the ring gear, so that an oil bath level up to the axis of rotation of the ring gear is sufficient to lubricate all the drive pinions.

Alternatively, the drive pinions can also be arranged uniformly distributed over the circumference of the ring gear, so that one or more drive pinions may be arranged outside or above the lubricant bath if the lubricant bath level is limited. These drive pinions that are not immersed in the oil or lubricant bath are then lubricated by the lubricant, which is carried by the ring gear and transferred to the drive pinions above. When used as a container winch or with comparably high operating times, the ring gear is more or less constantly in motion, so that the lubricant carried along by the ring gear can also sufficiently lubricate the pinions located above the lubricant bath.

In order to be able to keep the amount of lubricant in the lubricant trough small, also at a higher lubricant level, a relatively close-fitting or small-dimensioned or as little voluminous oil trough as possible is used in further development of the invention, which surrounds the ring gear or a sector of the ring gear relatively closely. In a further development of the invention, the lubricant trough can be configured in the form of a disk and/or ring and have an axial thickness which is narrower than 200% or narrower than 150% of the axial thickness of the ring gear arranged in the disk-shaped oil sump. Due to such a narrow axial thickness of the lubricant trough, the sump walls running transversely to the direction of rotation of the ring gear are seated relatively close to the end-faces of the ring gear, so that small amounts of lubricant are stored there.

Irrespective of such a close seat in the axial direction, the lubricant trough can also border relatively close to the plunging sector of the ring gear in the circumferential direction or border the drive pinions provided there.

In order to also have a small gap dimension or a small dead volume in the circumferential direction, the lubricant sump can have circumferential bulges which accommodate the drive pinions and fit around the drive pinions, while circumferential constrictions can be provided between said bulges, at which the circumferential wall of the lubricant sump between two adjacent drive pinions in each case fits closer to the ring gear.

Said bulging and constriction structure of the circumferential side of the lubricant tray can be used both with an externally toothed ring gear and drive pinions arranged accordingly on the outer circumference of the ring gear and also with internally toothed ring gears and drive pinions arranged accordingly on the inner circumference of the ring gear.

The lubricant through can, for example, be configured in an annular shape and extend around the toothing ring of the ring gear. For example, plates or lubricant trough walls can be arranged on the end-face of the ring gear, which enclose the ring gear in an annular shape. The annular enclosure can be flooded in the lower sector or in the lower half in order to form said lubricant bath.

In order to also avoid overheating of the lubricant with a small-volume oil or lubricant bath, a circulating lubrication system can be provided in a further development of the invention, which can lead the lubricant out of the reservoir around the ring gear and, for example, through an external cooler.

Alternatively, or in addition to an oil bath or lubricant bath lubrication, however, the drive pinions can also be lubricated by an oil mist or lubricant mist lubrication. This type of mist lubrication can in particular avoid the splash losses of a lubricant bath, which can make the operation of the cable winch even more efficient and increase its efficiency. In principle, mist lubrication can also be combined with lubricant bath lubrication, for example in such a way that a top drive pinion that is not immersed in the oil bath is sprayed directly with lubricant mist by a nebulizer. However, in order to avoid splash losses as completely as possible, all drive pinions can also be lubricated by lubricant mist. In this case, several nebulizers are advantageously provided, each of which directs or sprays lubricant mist specifically onto a respective drive pinion.

In order to avoid tooth fractures in the event of overloads, which would cause major destruction and lead to longer downtimes, predetermined breaking points can be provided between the drive pinions and the drive motors in a further development of the invention, which break and cut the rotationally fixed connection between the motor shaft and the respective drive pinion before excessive torque shocks would damage the teeth of the drive pinion or the teeth of the ring gear.

For example, the drive shaft between the drive motor and drive pinion can have a weakening point, for example in the form of a diameter taper and/or a predetermined breaking notch.

In order to permit simple replacement of the respective drive group, for example replacement of a drive pinion and/or the motor shaft and/or the connecting shaft in the event of breakage or also only in the event of normal wear, a torque-transmitting plug connection can be provided between the drive pinions and the motor shafts of the drive motors in a further development of the invention, which transmits torque in a mated state and can be axially released so that, for example, the drive motor with its motor shaft stub can simply be pulled off.

For example, said torque-transmitting plug connection can be a spline connection, a polygonal shaft connection or a splined shaft connection. In an advantageous further development of the invention, a feather key connection can also be provided as a torque-transmitting plug connection, wherein the feather key can also form the predetermined breaking point if it shears off under excessive load.

Said ring gear cable winch can be used in particular as a container winch and can make full use of its advantages in container handling. Container winches usually run full-time at the upper limit of their capacity, unlike the hoisting winches of tower cranes or passenger elevator winches, for example, which, unlike container winches, always have longer rest phases. Due to the full-time operation under high loads or at full power, the thermal load on container winches is relatively high, which can be controlled by the oil lubrication described above and limited by the high energy efficiency. On the other hand, the distribution of the drive power to many small drive motors, each with separate, independent drive trains to the ring gear, ensures a high level of reliability. Furthermore, the wide speed range of the fast-running, smaller drive motors takes account of the fact that container winches move high loads cyclically and return more.

### BRIEF DESCRIPTION OF THE DRAWINGS

The invention will be explained in more detail in the following with respect to preferred embodiments and to associated drawings. The drawings show:

FIG. 1: shows a schematic side view of a container or ship-to-shore crane with a ring gear cable winch according to an advantageous embodiment of the invention,

FIG. 2: shows a sectional view of the ring gear cable winch of the crane in FIG. 1 in a version with an internally toothed ring gear and drive motors concentrated in the lower half, wherein the sectional view shows one of the drive motors and its drive pinion meshing with the ring gear,

FIG. 3: shows an end-face front view of the ring gear cable winch from FIG. 2, which shows the drive motor arrangements distributed over the circumference and concentrated in the lower half,

FIG. 4: shows a sectional view of a ring gear cable winch similar to FIG. 2 according to a further embodiment of the invention, in which the ring gear is externally toothed,

FIG. 5: shows an end-face front view of the ring gear cable winch from FIG. 4, showing the distribution of the drive motors over the lower half of the circumference of the ring gear,

FIG. 6: shows a sectional view of a ring gear cable winch similar to FIGS. 2 and 4 according to a further advantageous embodiment of the invention, in which 2 ring gears are provided on opposite flanged pulleys of the cable drum, which are each driven by a plurality of drive motors, wherein the ring gears are each externally toothed,

FIG. 7: shows an end-face front view of the ring gear cable winch from FIG. 6, showing the drive motors arranged uniformly distributed around the circumference,

FIG. 8: shows a sectional view of a ring gear cable winch similar to FIGS. 2, 4 and 6 according to a further advantageous embodiment of the invention, in which the ring gear is externally toothed and the drive motors are arranged without overlapping the cable drum,

FIG. 9: shows an end-face front view of the ring gear cable winch from FIG. 8, which shows the arrangement of the drive motors distributed over the circumference,

FIG. 10: shows a sectional view of a ring gear cable winch with two ring gears similar to FIG. 6, according to a further embodiment of the invention, in which the ring gears are internally toothed,

FIG. 11: shows an end-face front view of the ring gear cable winch from FIG. 10, which shows the arrangement of the drive motors uniformly distributed over the circumference,

FIG. 12: shows a sectional view of a ring gear cable winch similar to FIG. 8, according to a further advantageous embodiment of the invention, according to which the ring gear is internally toothed and the drive motors are arranged without overlapping with the cable drum,

FIG. 13: shows an end-face front view of the ring gear cable winch in FIG. 12, showing the drive motors uniformly distributed around the circumference,

FIG. 14: shows a perspective half-section of a ring gear cable winch similar to FIG. 8, wherein an annular oil pan is shown around the externally toothed ring gear and the drive pinions meshing therewith, and

FIG. 15: shows a sectional view of a drive pinion meshing with the externally toothed ring gear and the drive motor connected to it, wherein the predetermined breaking point and the plug connection in the area of the connecting shaft between the drive motor and drive pinion are shown in an exploded view.

### DETAILED DESCRIPTION

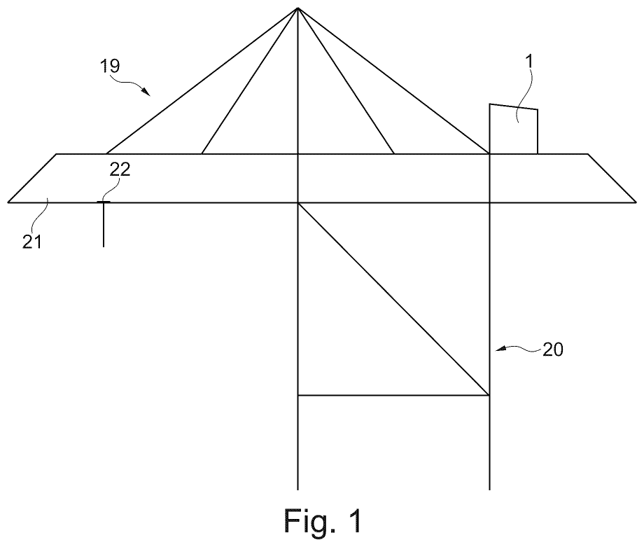

As shown in FIG. 1, the ring gear cable winch 1 can be used in a container handling crane or an STS crane 19 and form its main hoisting winch, cf. FIG. 1. Such a container handling crane 19 can comprise a fixed or also a movable, mast-shaped or gantry-like substructure 20, which can be moved, for example, on rails or tracks or also by a wheeled chassis on a rail-free surface. The substructure 20 carries a jib or gantry 21, which can be aligned horizontally and carries a trolley 22, which can be moved along the gantry 21. A hoist cable 23 descends over the trolley 22 and can be wound up and lowered by the toothed ring winch 1.

As shown in FIG. 1, said ring gear cable winch 1 may be arranged on the gantry 21 of the crane 19 and may, for example, be arranged in a machine house.

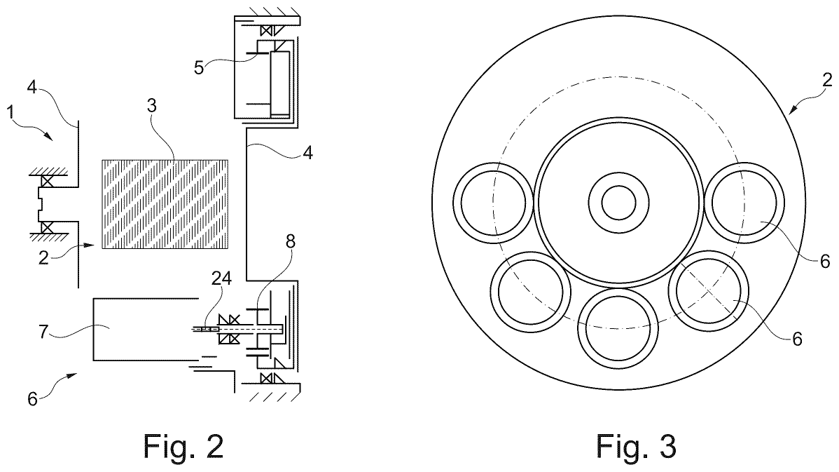

As shown in FIGS. 2 and 3, the ring gear cable winch 1 comprises a cable drum 2, the drum body 3 of which is provided with a cable groove on the circumferential side, but may also be configured to be smooth. The end-face of the drum body 3 can be bordered by flanged pulleys 4, which limit the winding space for the rope to be wound up between them.

A ring gear 5 can be arranged on at least one of said flanged pulleys 4, which can be rigidly connected directly to the flanged pulleys 4 or can also be connected directly to the drum body 3 in a rotationally fixed manner.

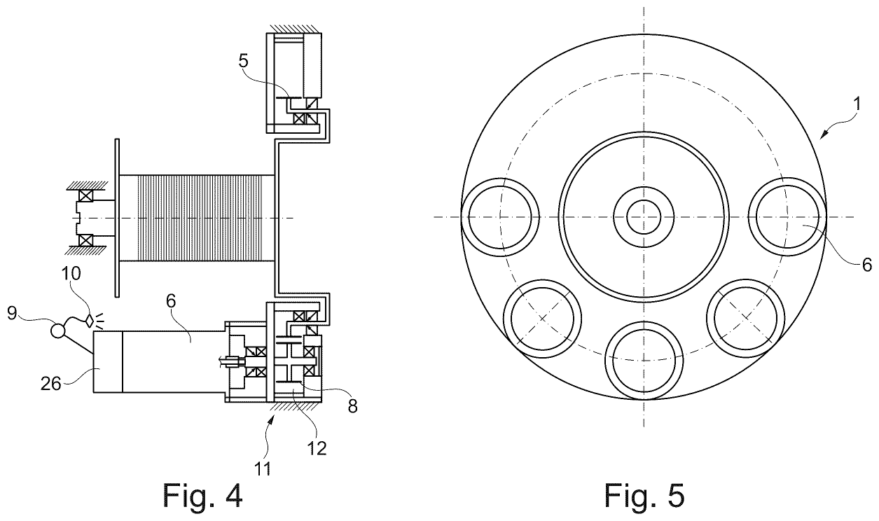

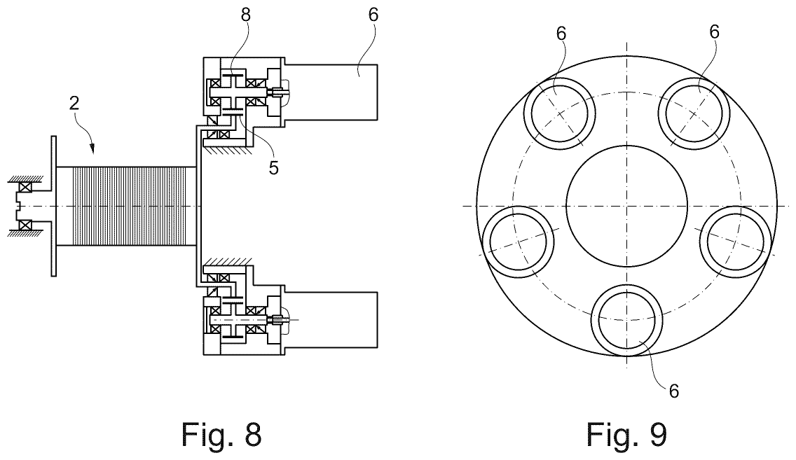

Said ring gear 5 can be internally toothed, cf. FIGS. 2, 10 and 12, or can also be externally toothed, cf. FIGS. 4, 6 and 8 as well as 14 and 15.

In addition to said ring gear 5, the drive device 6 for driving the cable drum 2 also comprises a plurality of drive motors 7, each of which drives a drive pinion 8 which meshes with the ring gear 5. Said drive motors 7 can advantageously be arranged with the axes of rotation of their motor shafts 24 parallel to the axis of rotation of the drum body 3, which is also the simultaneous axis of rotation of the ring gear 5. In this case, the axes of rotation of the motor shafts 24 can be more or less radially spaced apart from the axis of the drum body, depending on whether the ring gear 5 is internally toothed or externally toothed.

As shown in FIGS. 3 and 5, the drive motors 7 may be arranged distributed over the circumference of the ring gear 5, but in this case they may be concentrated in a lower half or a lower sector of the ring gear 5. In particular, all drive motors 7 can be arranged with their motor shaft axis along the lower half of the ring gear 5 in order to be lubricated by an oil bath 12, as will be explained.

In principle, however, it is also possible to arrange the drive motors 7 uniformly distributed over the total circumference of the ring gear 5, cf. FIGS. 7, 9, 11 and 13. In this case, spray lubrication can be provided in order to achieve efficient lubrication.

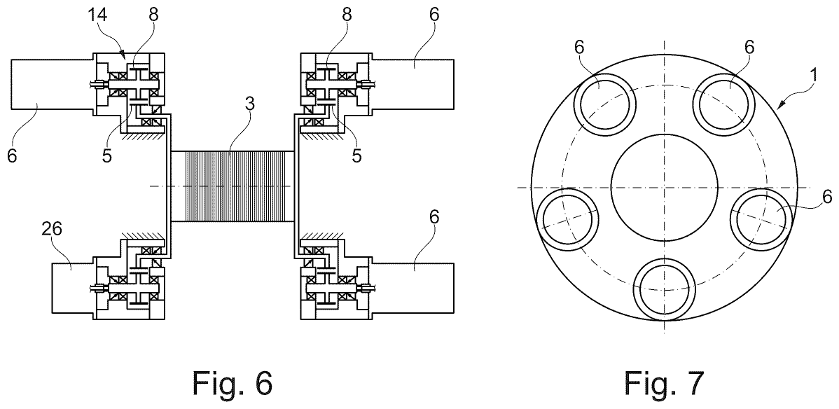

In this case, the drive motors 7 can be arranged without overlapping with the drum body 3, i.e. not overlapping in the radial direction with the drum body 3, but projecting away from said cable drum 2 from one or also both end-faces of the cable drum 2, cf. FIGS. 6, 8, 10 and 12.

Alternatively, however, the drive motors 7 can also be arranged overlapping the drum body 3 in a radial direction. In this case, the drive motors 7 can extend from the ring gear 5 on one end-face of the cable drum 2 towards the opposite end-face of the cable drum 2, cf. FIGS. 2 and 4.

In order to be able to brake the cable drum 2 and/or hold it at a standstill, one or more brakes 26 may be provided, as shown by way of example in FIG. 4, which may be provided on one or more drive motors 7, in particular combined therewith to form a pre-assembled drive/brake assembly. For example, the brake 26 can be flange-mounted on an end-face of the respective drive motor 7, for example the end-face facing away from the drive pinion 8, or possibly also the end-face facing the drive pinion 8.

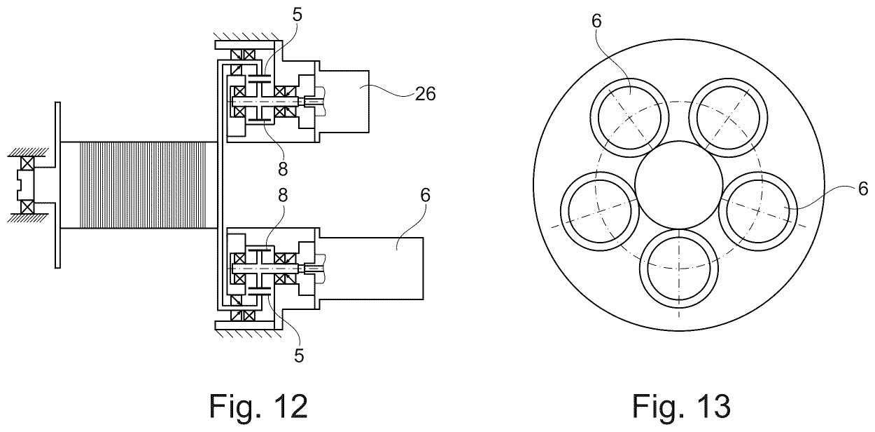

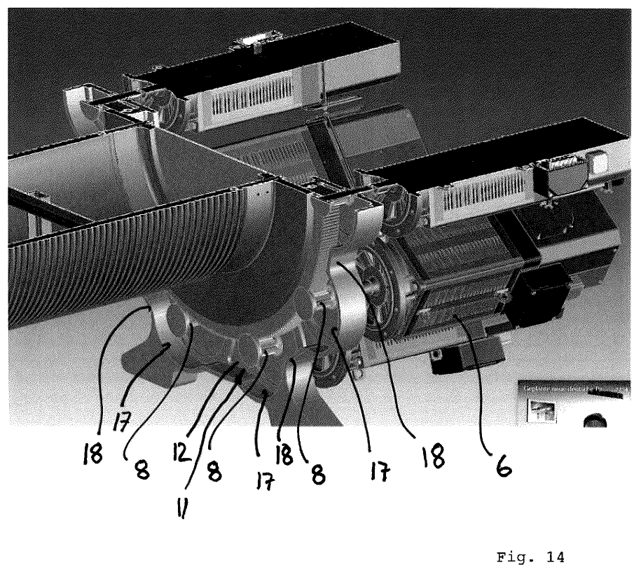

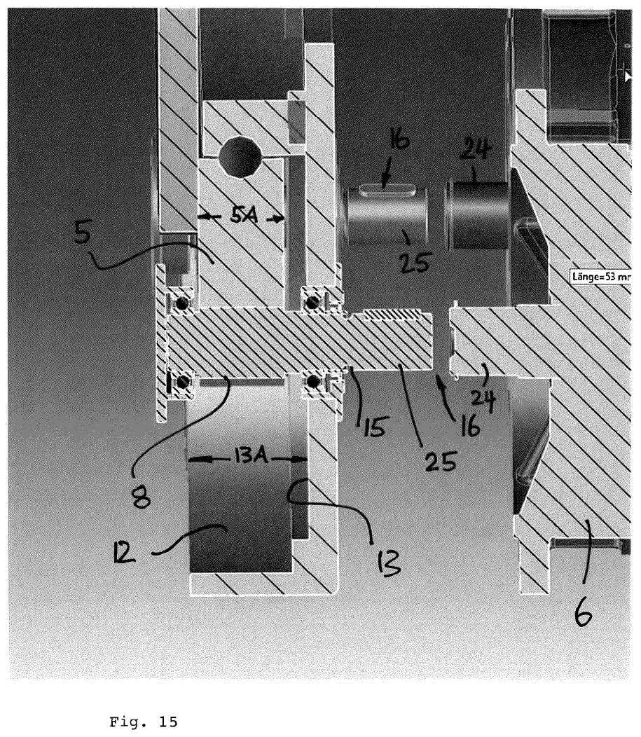

Alternatively or in addition to a brake 26 integrated into a drive motor 7, a separate brake 26 can also be provided, which is assigned to a drive or, in this case, brake pinion 8 without a drive motor 7, which meshes with the ring gear 5 and can be seated next to or between the drive motors 7 distributed around the circumference, cf. FIGS. 6 and 12. The brake 26 can be a disk or multiple-disk brake or, in the case of a pure holding brake, also a claw brake, and independently thereof act on a connector shaft 25, which is rotationally fixedly connected to the pinion 8.

As FIG. 15 and also FIGS. 2, 4, 6, 8, 10 and 12 show, it is provided according to the invention that the drive pinions 8 meshing with the ring gear 5 are each connected directly, i.e. without transmission and gear ratio as well as reduction ratio, in a rotationally fixed manner to the motor shafts 24 of the respective drive motors 7, so that the drive pinions 8 rotate at the same angular speed or rotational speed as said motor shafts 24 of the drive motors 7.

In this case, said drive pinions 8 may be arranged coaxially to the respective motor shaft 24 and may be seated on said motor shaft 24 of the drive motor 7 itself. Advantageously, however, the respective motor shaft 24 can be extended, so to speak, by a pinion shaft 25. This pinion or connector shaft 25 extends coaxially to the motor shaft 24 and is connected to the latter by a rotationally fixed connection 16, cf. FIG. 15.

Said plug connection 16 may comprise, for example, a feather key connection or another rotationally fixed shaft hub connection such as a spline connection or splined connection. Such a plug connection 16 makes it easy to remove the drive pinion 8 together with the connecting shaft 25 from the motor shaft 24 or, conversely, to remove the drive motor 7 from the mounted drive pinion 8, for example if the connecting shaft 25 has broken. Furthermore, common types of clutches can also be used, for example curved-tooth or claw clutches, but in particular also torque-limiting clutches such as slip clutches.

In order to prevent damage to the teeth of the drive pinion 8 or the ring gear 5, said connecting shaft 25 can advantageously be provided with a predetermined breaking point 15, which breaks before overloads could damage the teeth of the toothing.

As shown in FIG. 15, such a predetermined breaking point 15 can, for example, comprise a cross-sectional weakening or a constriction or a circumferential groove on the connecting shaft 25.

Alternatively, or additionally, however, the feather key of the aforementioned feather key connection of the plug connection 16 can also serve as a predetermined breaking point, which shears off when overloaded.

As the figures show, the drive device 6 thus comprises a ring gear 5 connected in a rotationally fixed manner to the cable drum 2 and a plurality of drive motors 7, which are distributed over the circumference of the ring gear 5 and each drive a drive pinion 8 meshing with the ring gear 5, wherein said drive pinions 8 are connected directly to the drive motors 7 without gearing and rotate with the motor shaft speeds of the drive motors 7.

The drive motors 7 can advantageously be electric motors without gearing.

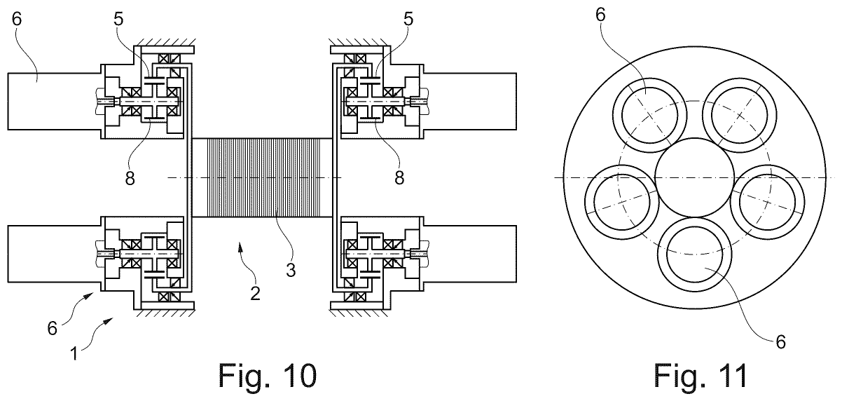

Regardless of the motor type, more than three or more than four, for example five or six drive motors 7 can be provided and connected to the same ring gear 5. In the case of two ring gears on opposite end-faces of the cable drum 2, three or more than four, for example five or six drive motors 7 can be provided and connected to each of the ring gears 5, cf. for example FIGS. 10 and 11.

Furthermore, it may be provided that the drive pinions 8 and the ring gear 5 are configured in such a way that the drive motors 7 have motor speeds in the range of 3,500 to 6,000 rpm or 4,000 to 5,000 rpm when driving the cable drum 2 as intended. However, as already mentioned at the beginning, the drive motors 7 can also operate at lower speeds, generally starting with speeds >0, in order to be able to perform, for example, fine positioning tasks such as placing a container on the ground.

Irrespective of this, the drive motors 7 can each have a moment of inertia of less than 2 kgm² or less than 1 kgm².

A control device 9 for controlling the drive motors 7, cf. FIG. 4, can advantageously have a failure operation mode in which, if the drive power failure of one or more drive motors 7 occurs, the drive powers of the remaining drive motors are increased, in particular uniformly increased, to at least partially compensate for the missing drive power.

In this case, said failure operation mode can comprise at least two compensation stages, namely a power mode in which the missing drive power is fully compensated by increasing the drive power of the remaining drive motors 7, and an economy mode in which the missing drive power is partially compensated by increasing the drive power of the remaining drive motors 7.

Preferably, the control device 9 can automatically switch to the failure operation mode if the drive power of one or more drive motors 7 fails, wherein a detection device 10 for detecting a drive power failure of each drive motor 7 can be provided, in particular configured to detect the drive power failure on the basis of the power consumption of the individual drive motors 7, wherein the control device 9 switches to the failure operation mode in dependence on a failure signal from the detection device 10.

To further increase efficiency, oil lubrication 11 can be provided for the drive pinions 8.

This oil lubrication 11 may comprise an oil bath 12 through which at least one lower sector of the ring gear 5 and/or at least one drive pinion 7 arranged on the lower sector of the ring gear 5 flows, wherein said oil bath 12 is limited by a disk-shaped oil trough 13 which surrounds the ring gear 5 and has an axial thickness 13A which is narrower than 200% or 150% of the axial thickness 5A of the ring gear 5, cf. FIG. 15.

In this case, the drive pinions 8 can be arranged in the oil trough 13 and the drive motors 7 can be arranged outside the oil trough 13. The brake 26 can also be arranged outside the oil bath 13, while the brake pinion meshing with the ring gear 5 can run in the oil bath 13.

In order to allow all pinions to be immersed in the bath as far as possible when the oil bath volume is limited, the drive pinions 8 can be arranged concentratedly towards the lower half of the ring gear 5 so that preferably all of them run in said oil bath 12.

Alternatively, however, it may also be provided that the drive pinions 8 are arranged uniformly distributed over the circumference of the ring gear 5 and at least one drive pinion 8 runs outside the oil bath 12.

In order to save unnecessary oil volume, it may be provided that the oil trough 13 has circumferential pinion bulges 17, each conforming to a drive pinion 8, and circumferential constrictions 18 between the pinion bulges 17.

Regardless of the specific oil pan contour, a recirculating lubrication system can be provided which can drain the oil from the oil bath, cool and/or filter it and return it to the oil bath.

Due to the small individual drive units, the system can be modularly constructed. a Lubricant supply and discharge openings or connections can be provided, for example, on the end-face oil trough walls that limit the end-face of the oil bath, in particular on the stationary wall through which the connecting shafts 25, to which the drive scribes are fastened, are guided into the oil chamber, cf. FIGS. 7, 9, 11, 13 and 15.

As an alternative or in addition to oil bath lubrication, the oil lubrication 11 can also comprise oil mist lubrication.

Furthermore, it may be provided that the oil mist lubrication comprises at least one nebulizer 14, which is configured to spray oil mist onto at least one drive pinion 8, cf. FIG. 6.

Such a nebulizer can also be assigned to each drive pinion 8.

In order to avoid downtimes due to tooth breakage, a predetermined breaking point can be provided between the drive pinions 8 and the drive motors 7 to protect the drive pinions 8 and the ring gear 5, cf. FIG. 15.

Irrespective of this, it can be useful if a torque-transmitting plug connection 16, in particular a feather key connection or a spline connection, is provided between the drive pinions 8 and the motor shafts of the drive motors 7.

The plug connection 16 is advantageously detachable, at least if the predetermined breaking point 15 is broken, so that it can be easily repaired or replaced. Alternatively, or in addition to a plug connection, however, clutches of various designs can also be provided in order to enable simple replacement.

As can be seen from the above description, the proposed ring gear cable winch is substantially characterized by the following aspects:
The invention is intended to replace existing designs of container handling winches and incorporate further advantages for the end application. The ring gear cable winch is intended to enable highly efficient and dynamic container handling. In this case, it offers a very high level of reliability with a simple, maintenance-friendly design.
By splitting the power between several small motors, these can be operated at a higher speed, which has the advantage of achieving a wider speed range, resulting in higher final speeds when running empty.
By splitting the power between several smaller motors and several independent gear meshes in the ring gear, a system design with several times redundancy is guaranteed. Simultaneously, each drive train can be independently protected by the already patented tooth breakage protection geometry.
Oil lubrication, particularly in the form of oil mist lubrication, ensures highly efficient lubrication and heat dissipation with at least one oil supply.
The smaller motors are more marketable and therefore more readily available. This ensures substantially cheaper new and ET procurement.
The drive concept with smaller motors reduces the overall inertia, which enables more dynamic drive behavior. Simultaneously, the system is less stressed in the event of a snag load (container gets caught) due to the faster deceleration of the rotating masses. The power consumption of the winch is significantly reduced due to the low inertia during acceleration, which leads to considerable energy savings.
Due to the reduced number of tooth engagements, the efficiency can be increased to an optimum.
In the event of maintenance, the individual drive units can be replaced quickly and easily, resulting in high availability.
Due to the small individual drive units, the system can be built up modularly, modular system.

We claim:

1. A ring gear cable winch having a cable drum and a drive device for driving the cable drum, wherein the drive device comprises:
a ring gear connected to the cable drum in a rotationally fixed manner,
a plurality of drive motors distributed over the circumference of the ring gear, and
a plurality of drive pinions meshing with the ring gear,
wherein the drive pinions are connected directly to the drive motors without gearing and configured to rotate at motor shaft speeds of the drive motors.

2. The ring gear cable winch of claim 1, wherein the drive motors are electric motors without gearing.

3. The ring gear cable winch of claim 1, wherein the plurality of drive motors comprises more than three drive motors connected to the same ring gear.

4. The ring gear cable winch of claim 1, wherein the drive pinions and the ring gear are configured such that the drive motors have motor shaft speeds in the range from 3,500 to 6,000 rpm or 4,000 to 5,000 rpm of the cable drum when driving the cable drum.

5. The ring gear cable winch of claim 1, wherein the drive motors each have a moment of inertia of less than 2 kgm² or less than 1 kgm².

6. The ring gear cable winch of claim 1, further comprising a control device for controlling the drive motors, wherein the control device has a failure operation mode in which, in the event of drive power failure of one or more drive motors, the drive powers of the remaining drive motors are increased uniformly in order to at least partially compensate for the drive power failure.

7. The ring gear cable winch of claim 6, wherein the failure operation mode comprises at least two compensation stages, wherein one of the compensation stages is a power mode in which the missing drive power is fully compensated by increasing the drive power of the remaining drive motors, and wherein another of the compensation stages is an economy mode in which the missing drive power is partially compensated by increasing the drive power of the remaining drive motors.

8. The ring gear cable winch of claim 7, wherein, in the event of drive power failure of one or more drive motors, the control device is configured to automatically switch to the failure operation mode, wherein the winch further comprises a detection device for detecting a failure of the drive power of each drive motor, wherein the detection device is configured to detect the drive power failure on the basis of the power consumption of the individual drive motors, wherein the control device switches to the failure operation mode in dependence on a failure signal from the detection device.

9. The ring gear cable winch of claim 1, further comprising a wet lubrication comprising an oil lubrication for the drive pinions.

10. The ring gear cable winch of claim 9, wherein the wet lubrication comprises a lubricant bath through which at least one lower sector of the ring gear and/or at least one drive pinion on the lower sector of the ring gear passes, wherein said lubricant bath is limited by a disk-shaped and/or ring-shaped lubricant trough which surrounds the ring gear and has an axial thickness which is narrower than 200% or 150% of the axial thickness of the ring gear.

11. The ring gear cable winch of claim 10, wherein the drive pinions are in the lubricant trough and the drive motors are outside the lubricant trough.

12. The ring gear cable winch according of claim 11, wherein the drive pinions are arranged concentratedly towards the lower half of the ring gear and all run in said lubricant bath.

13. The ring gear cable winch of claim 10, wherein the drive pinions are arranged uniformly distributed over the circumference of the ring gear and at least one drive pinion (8) runs outside the lubricant bath.

14. The ring gear cable winch of claim 10, wherein the lubricant trough has circumferential pinion bulges and circumferential constrictions, wherein each of the circumferential pinion bulges conforms to a drive pinion, and wherein the circumferential constrictions are between the pinion bulges.

15. The ring gear cable winch of claim 10, wherein the wet lubrication comprises a mist lubrication.

16. The ring gear cable winch of claim 15, wherein the mist lubrication comprises at least one nebulizer configured to spray lubricant mist onto at least one drive pinion.

17. The ring gear cable winch of claim 1, further comprising a predetermined breaking point for protecting the ring gear between the drive pinions and the drive motors.

18. The ring gear cable winch of claim 1, further comprising a torque-transmitting plug connection between the drive pinions and the motor shafts of the drive motors, and wherein the torque-transmitting plug connection comprises a feather key connection or a splined connection.

19. The ring gear cable winch of claim 18, wherein the plug connection is configured to be released at least when the predetermined breaking point is broken.

20. A lifting gear with a ring gear cable winch configured according to claim 1.

21. The lifting gear of claim 20 configured as a container crane.
